(19) United States
(12) Patent Application Publication
(10) Pub. No.: US 2021/0384676 A1
(43) Pub. Date: Dec. 9, 2021

(54) ADJUSTABLE EXTENSION CORD LOCK

(71) Applicant: Julio C. Rivera-Torres, Kissimmee, FL (US)

(72) Inventor: Julio C. Rivera-Torres, Kissimmee, FL (US)

(21) Appl. No.: 17/337,652

(22) Filed: Jun. 3, 2021

Related U.S. Application Data
(60) Provisional application No. 63/034,211, filed on Jun. 3, 2020.

(51) Int. Cl. H01R 13/639

(52) U.S. Cl. CPC H01R 13/6392

(57) ABSTRACT

An adjustable extension cord lock is provided. The adjustable extension cord lock includes a first bracket and a second bracket. The first bracket is connected to the second bracket in a way that forms a gap between the first bracket and the second bracket. The first bracket has a first aperture. The second bracket has a second aperture. The first aperture is in linear alignment with the second aperture. A lock is designed to secure the position of the first bracket relative to the second bracket.

### CROSS REFERENCE TO RELATED APPLICATIONS

This application claims the benefit of U.S. Provisional Application No. 63/034,211 filed on Jun. 3, 2020. The above identified patent application is herein incorporated by reference in its entirety to provide continuity of disclosure.

### BACKGROUND OF THE INVENTION

The present invention relates to an adjustable extension cord lock. More specifically, the present device provides a mechanism for securing a pair of electrical cords that could otherwise become separated.

Extension cords are a necessary component for bridging a gap between an electrical device and a source of electricity, such as a power socket. Sometimes, an electrical device must be used at a far enough distance away from the power source that more than one extension cord may be needed. This is particularly the case with electrical devices that do not comprise electrical cords themselves, such as drills or leaf blowers.

When extension cords are joined together, the male interface of the extension cord connected to the electrical device is connected to the female interface of the extension cord that is connected to the power source. Generally, the connection points to the electrical device and to the power source are stable. However, the connection point between the extension cords is generally subjected to a higher level of movement and, therefore, subjected to the greatest risk of accidental separation. Such accidental separations are inconvenient for the electrical device operator and can result in additional time spent on the project, as well as frustration. In some cases, a sudden loss of power to an electrical device may even be harmful or dangerous.

Therefore, there is a defined need among the known prior art references for a device that strengthens the connection between two extension cords, such as to reduce the risk of accidental separations of extension cords while operating an electrical device.

### SUMMARY OF THE INVENTION

In view of the foregoing disadvantages inherent in the known types of cord locking methods and devices now present in the prior art, the present invention provides an adjustable extension cord lock wherein the same can be utilized for providing convenience for the user when ensuring a strong connection between two extension cords.

The present system comprises a first bracket and a second bracket. The first bracket is engaged with a second bracket, such that a gap is defined between the first bracket and the second bracket. The first bracket comprises a first aperture. The second bracket comprises a second aperture. The first aperture and the second aperture are in a parallel linear alignment with the first bracket and the second bracket. A lock is configured to secure the position of the first bracket relative to the second bracket.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the adjustable extension cord lock.

FIG. 2 shows a perspective view of an embodiment of the adjustable extension cord lock in use.

FIG. 3 shows a perspective view of an embodiment of the adjustable extension cord lock in use.

FIG. 4 shows a cross-sectional view of an embodiment of the adjustable extension cord lock.

### DETAILED DESCRIPTION OF THE INVENTION

Reference is made herein to the attached drawings. Like reference numerals are used throughout the drawings to depict like or similar elements of the adjustable extension cord lock. The figures are intended for representative purposes only and should not be considered to be limiting in any respect.

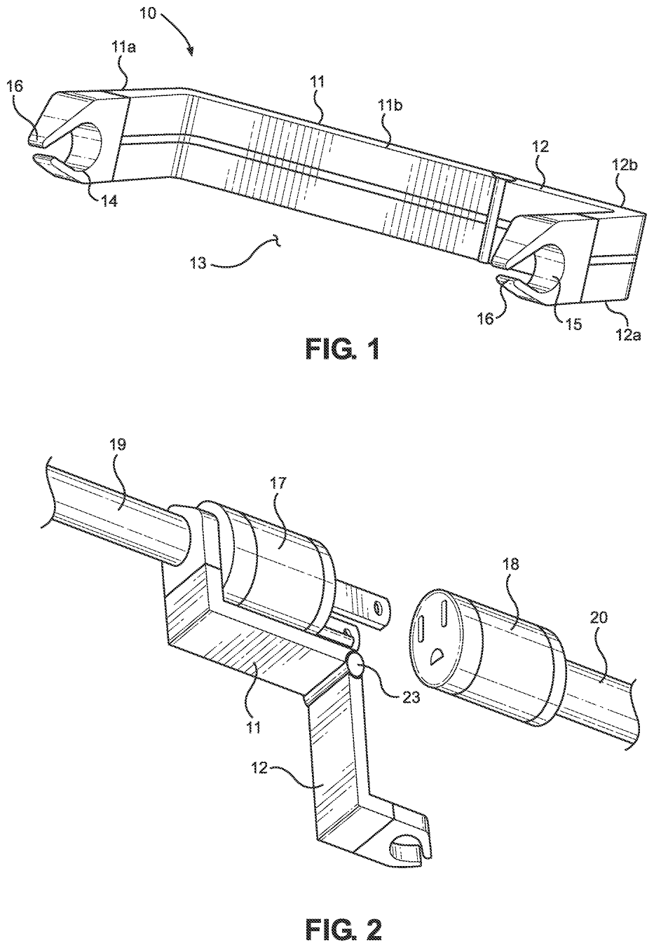

Referring now to FIG. 1, there is shown a perspective view of an embodiment of the adjustable extension cord lock. The adjustable extension cord lock 10 is defined by a first bracket 11 and a second bracket 12. The first bracket 11 is engaged with the second bracket 12, such that a gap 13 is defined between the first bracket 11 and the second bracket 12. The gap 13 is adjustable, such as to enable protection of electrical plugs of various lengths and thicknesses. In the illustrated embodiment, the first bracket 11 and the second bracket 12 each consist of a first member 11a, 12a perpendicularly joined with a second member 11b, 12b. The first bracket 11 and the second bracket 12 may be of identical dimensions or may be of alternate dimensions. The first bracket 11 and the second bracket 12 are made of a durable material, such as hardened plastic, such as to maintain the shape and position of the first bracket 11 and the second bracket 12.

The first bracket 11 comprises a first aperture 14. The second bracket 12 comprises a second aperture 15. Each of the first aperture 14 and the second aperture 15 are dimensioned to receive an electrical cord, such as an extension cord, therein. In some embodiments, the first aperture 14 and the second aperture 15 are identical in diameter. In other embodiments, the first aperture 14 and the second aperture 15 are of different diameters. The first aperture 14 and the second aperture 15 are in a linear alignment with each other which the first bracket 11 and the second bracket 12 are disposed in an active configuration. As such, the position of the electrical plugs on which the adjustable extension cord lock 10 is being used will be preserved. Furthermore, in the illustrated embodiment, the first aperture 14 and the second aperture 15 each comprises a slot 16 extending through the first bracket 11 and the second bracket 12, respectively. In the illustrated embodiment, the first aperture 14 and the second aperture 15 are provided on a clip structure attached to the 1 distal ends of the first bracket 11 and the second bracket 12. The clip structures are made of rubberized materials that can be expanded and biased in a closed position to secure an electrical cord.

Referring now to FIG. 2, there is shown a perspective view of an embodiment of the adjustable extension cord lock in use. In the illustrated embodiment, the first bracket 11 is joined with the second bracket 12 via a hinge 23. The hinge 23 is configured to enable rotation of the first bracket 11 and the second bracket 12 relative to each other. In other embodiments, the first bracket 11 and the second bracket 12 may be joined by another structure or configuration. In some embodiments, the hinge 23 comprises a lock, such as to secure the hinge 23 in a desired configuration. As such, the first bracket 11 and the second bracket 12.

In use, the first bracket 11 is affixed to a first extension cord 19 at a position behind the first extension cord plug 17. Once the location of the first bracket 11 is secured, the second bracket 12 is affixed to a second extension cord 20 at a position behind the second extension cord plug 18. The position of the first bracket 11 relative to the second bracket 12 is secured in place via a lock. As such, the first extension cord 19 and the second extension cord 20 will be maintained in a joined configuration.

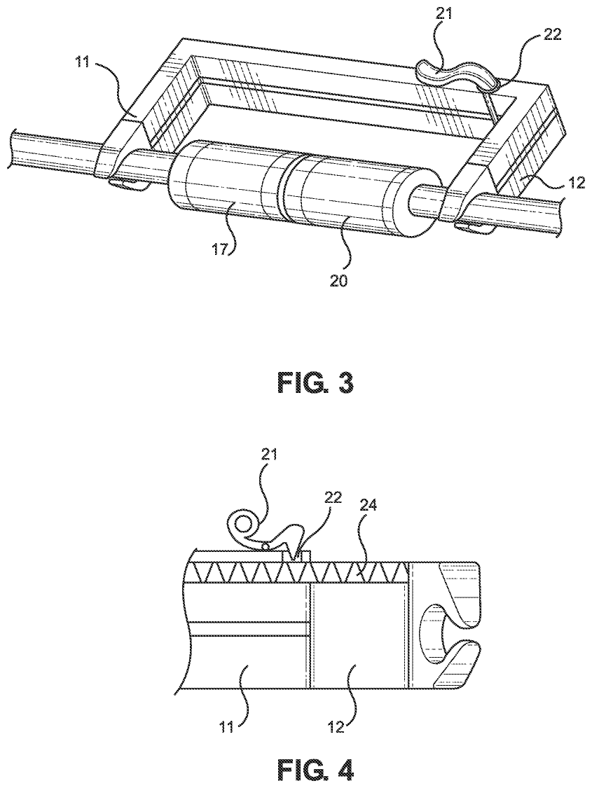

Referring now to FIG. 3, there is shown a perspective view of an embodiment of the adjustable extension cord lock in use. In the illustrated embodiment, the first bracket 11 defines a channel in which the second bracket 12 is slidably receivable. As such, the user may adjust the length of the gap between the first aperture and the second aperture to accommodate a pair of plugs 17, 18 of a desired length or thickness.

Furthermore, in the illustrated embodiment, the adjustable extension cord lock further comprises a lock 21. The lock 21 is configured to secure the position of the first bracket 11 relative to the second bracket 12. In the illustrated embodiment, the lock 21 is a lever-style lock that is biased in a closed position. Furthermore, in the illustrated embodiment, a lock aperture 22 is disposed in the first bracket 11. The lock aperture 22 enables the lock 21 to contact an interface disposed on the second bracket 12.

Referring now to FIG. 4, there is shown a cross-sectional view of an embodiment of the adjustable extension cord lock. In the illustrated embodiment, the lock 21 comprises a lock aperture 22. The lock 21 comprises a protrusion that extends through the first bracket 11 via the lock aperture 22, such as to contact the upper surface of the second bracket 12. In the illustrated embodiment, the upper surface of the second bracket 12 comprises a plurality of ridges 24, wherein the ridges 24 are dimensioned to receive the protrusion of the lock 21. As such, the user may define a desired length between first aperture and the second aperture to receive a desired pair of electrical plugs.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) An adjustable extension cord lock, comprising:
a first bracket;
a second bracket;
the first bracket engaged with the second bracket, such as to define a gap between the first bracket and the second bracket;
the first bracket comprising a first aperture;
the second bracket comprising a second aperture.

2) The adjustable extension cord lock of claim 1, wherein the first aperture comprises a first slot extending through the first bracket and the second aperture comprises a second slot extending through the second bracket.

3) The adjustable extension cord lock of claim 1, wherein the first bracket and the second bracket each consist of a first member perpendicularly joined with a second member.

4) The adjustable extension cord lock of claim 1, wherein the first bracket defines a channel dimensioned to slidably receive the second bracket therein.

5) The adjustable extension cord lock of claim 1, wherein the first bracket and the second bracket comprise identical dimensions.

6) The adjustable extension cord lock of claim 1, wherein the first aperture and the second aperture are of identical diameters.

7) The adjustable extension cord lock of claim 1, wherein the first bracket is joined with the second bracket via a hinge.

8) The adjustable extension cord lock of claim 1, further comprising a lock configured to secure the position of the first bracket relative to the second bracket

9) The adjustable extension cord lock of claim 8, wherein the lock is disposed proximate to a lock aperture through the first bracket, such that the lock can engage the second bracket through the first bracket.
